(19) United States
(12) Patent Application Publication
(10) Pub. No.: US 2010/0260544 A1
(43) Pub. Date: Oct. 14, 2010

(54) Combination of Bicycle Rear Wheel Hub and Sprocket Set

(76) Inventor: Pi-Yun Chiang, Ta Ya Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,463

(22) Filed: Apr. 9, 2009

(51) Int. Cl. B25G 3/28; B60B 27/00

(52) U.S. Cl. 403/359.1; 301/110.5

(57) ABSTRACT

A connection tube of bicycle rear wheel hub includes a connection portion and an engaging portion one two ends of the connection tube, the connection portion is connected to the bicycle rear wheel hub. The engaging portion is a hollow tube and four elongate driving ribs extend radially from an outer periphery of the engaging portion. Each driving rib includes a driving surface and an inclined surface on two sides thereof. The driving surface is perpendicular to the outer periphery of the engaging portion. A positioning rib extends radially from an outer periphery of the engaging portion and is located between two driving ribs. Only the driving surface contacts the engaging ribs of the sprocket set.

### FIELD OF THE INVENTION

The present invention relates to a bicycle rear hub and more particularly, to an engaging portion on a bicycle rear hub rear wheel hub so as to be connected with a CAMPAGNOLO sprocket set.

### BACKGROUND OF THE INVENTION

A conventional derailleur system for bicycle generally includes at least one chain ring connected with the crank, a sprocket set connected to one end of the rear wheel hub, and a chain which transfers the driving force from the chain ring to one of the sprockets of the sprocket set. Generally, the sprocket set includes 5 to 10 sprockets of different number of teeth and the shifting mechanism of the derailleur system shifts the chain from one sprocket to another so as to obtain desired speed.

There are two main brand names for the connection tubes of the rear wheel hubs, which are SHIMANO and CAMPAGNOLO, the difference between the connection tubes of the two brands is the engaging portion on the rear wheel hub.

As shown in FIG. 9, SHIMANO's sprocket set 70 includes multiple sprckets 71 and each sprocket 71 has an engaging hole 72, nine protrusions 73 extend inward from the periphery of the engaging hole 72. The connection tube 74 on the rear wheel hub includes multiple ribs 75 on an outer periphery of an end thereof and the ribs 75 are engaged with the recesses between the protrusions 73 so that the driving force can be transferred from the sprocket set 70 to the connection tube 74 to drive the rear wheel.

As shown in FIG. 10, CAMPAGNOLO's sprocket set 80 includes multiple sprckets 81 and each sprocket 81 has an engaging hole 82, four protrusions 83 extend inward from the periphery of the engaging hole 82. One of the protrusions 83 has a stepped outer profile. The connection tube 84 on the rear wheel hub includes four ribs 85 on an outer periphery of an end thereof and each rib 85 has a recess 851 with which the protrusions 83 are engaged. The driving force can be transferred from the sprocket set 80 to the connection tube 84 to drive the rear wheel.

It is noted that, for the connection tube 84 of CAMPAGNOLO, each rib 85 has a recess 851 whose two insides are in contact with the two outsides of the protrusion 83. However, the direction of rotation of the sprocket set 80 is fixed so that only the inside “A” of the recess 851 actually transfers the force, and the other inside “B” does not provide such function.

The requirement for having the precision of the recess 851 is high so that the protrusion 83 can properly engage with the recess 851 and successfully transfer force to the rear wheel. The assemblers have to check carefully for the engagement of the protrusions 83 and the recesses 851 and this increases the time required and the cost of labor cost. Besides, the inside “B” does not have the same function as the inside “A”, the material and manufacturing processes to the inside “B” become a waste.

The present invention intends to provide a connection tube of a rear wheel hub wherein multiple driving ribs and one positioning rib located on the engaging portion of the connection tube. Each driving rib has a driving surface and an inclined surface on two sides thereof, only the driving surface contacts the engaging rib in the engaging hole of the sprockets.

### SUMMARY OF THE INVENTION

The present invention relates to a connection tube of bicycle rear wheel hub and the connection tube includes a connection portion extending axially from a first end thereof so as to be connected with the bicycle rear wheel hub, and an engaging portion extends axially from a second end of the connection tube so as to extend from an end of the rear wheel hub. The engaging portion is a hollow tube and four driving ribs extend radially from an outer periphery of the engaging portion and each driving rib includes a driving surface and an inclined surface on two sides thereof. The driving surface is perpendicular to the outer periphery of the engaging portion. A positioning rib extends radially from an outer periphery of the engaging portion and is located axially on the engaging portion. The positioning rib is located between two driving ribs.

The primary object of the present invention is to provide a connection tube on the rear wheel hub and four driving ribs and one positioning rib located on the outer periphery of the connection tube. Each of the driving ribs includes a driving surface and an inclined surface on two sides thereof and only the driving surface transfers the force from the sprocket set to the rear wheel hub.

Another object of the present invention is to provide a connection tube on the rear wheel hub wherein the manufacturing cost of the connection tube is significantly reduced because only the driving surface contacts the engaging rib of the sprocket set.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the connection tube connected to the rear wheel hub and the sprocket set of the present invention;

FIG. 2 is an exploded view to show the connection tube and the rear wheel hub of the present invention;

FIG. 3 is an end view to show the connection tube of the present invention;

FIG. 4 is a partial side cross sectional view to show that the sprocket set is mounted to the connection tube of the present invention;

FIG. 5 is a partial end cross sectional view to show that the sprocket set is mounted to the connection tube of the present invention;

FIG. 6 shows that the driving surfaces of the driving ribs contact the engaging ribs of the sprocket set;

FIG. 7 is a perspective view to show another embodiment of the connection tube of the present invention;

FIG. 8 shows the connection of the connection tube in FIG. 7 and the sprocket set;

FIG. 9 shows the connection of the connection tube of SHIMANO and the sprocket set, and

FIG. 10 shows the connection of the connection tube of CAMPAGNOLO and the sprocket set.

### DETAILED DESCRIPTION OF THE PREFERRED EMBODIMENT

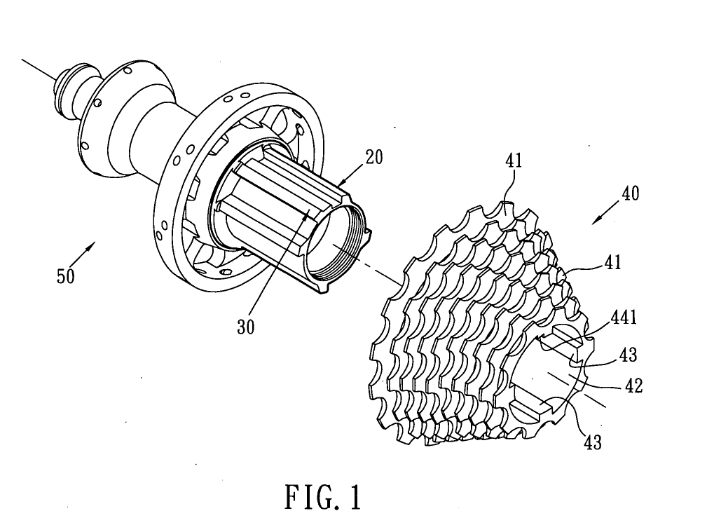

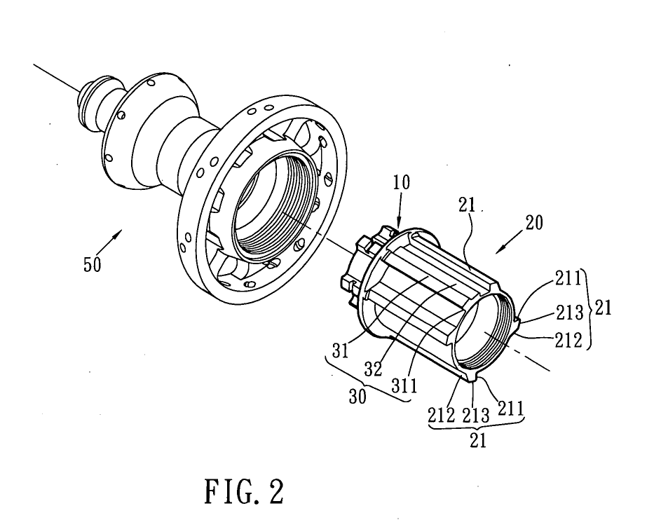

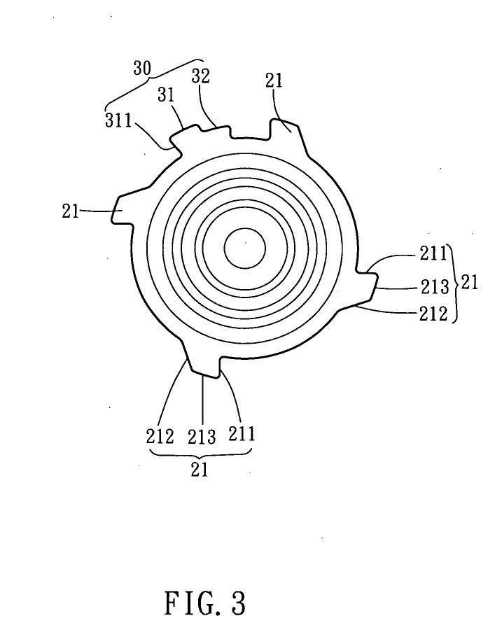

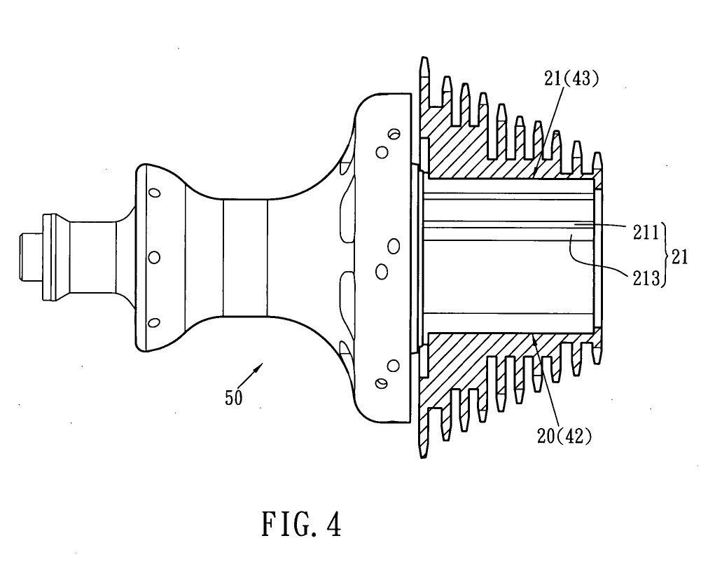

Referring to FIGS. 1 to 5, the connection tube of bicycle rear wheel hub of the present invention comprises a connection portion 10 extending axially from a first end thereof and an engaging portion 20 extends axially from a second end of the connection tube. The connection portion 10 is connected with one end of the rear wheel hub 50. The engaging portion 20 extends from the end of the rear wheel hub 50 and is a hollow tube. Four driving ribs 21 extend radially from an outer periphety of the engaging portion 20, and the driving ribs 21 are located axially on the engaging portion 20. Each driving rib 21 includes a driving surface 211 and an inclined surface 212 on two sides thereof. A crown surface 213 is connected between the driving surface 211 and the inclined surface 212 of each driving rib 21. The driving surface 211 is perpendicular to the outer periphery of the engaging portion 20 and the inclined surface 212 is inclined relative to the outer periphery of the engaging portion 20. A positioning rib 30 is located between two adjacent driving ribs 21 and extends radially and axially from an outer periphery of the engaging portion 20. The positioning rib 30 is a stepped rib and includes a first step 31 and a second step 32 which is shorter than the first step 31. The first step 31 of the positioning rib 30 is located on the same side as the driving surface 211 of each driving rib 21.

A sprocket set 40 is composed of multiple sprockets 41 and each sprocket 41 has an engaging hole 42 with which the engaging portion 20 is engaged. Four engaging ribs 43 extend inward from the inner periphery of the engaging hole 42 so as to be engaged with the driving ribs 21 of the engaging portion 20. An assembly rib 44 extends inward from the inner periphery of the engaging hole 42 and located between the adjacent two engaging ribs 43.

When mounting the sprocket set 40 to the engaging portion 20 of the rear wheel hub 50, the diving ribs 21 are located between the engaging ribs 43 of the sprocket set 40. The driving surfaces 211 of each driving rib 21 contacts the side of the engaging rib 43 corresponding thereto. The positioning rib 30 is engaged with the assembly rib 44, wherein the assembly rib 44 is a stepped rib and includes an engaging step 441 with which the second step 32 of the positioning rib 30 is in contact. The crown surface 213 has a width between 2 mm to 4 mm, which is smaller than that of SHIMANO. The height of the driving ribs 21 is larger than that of SHIMANO.

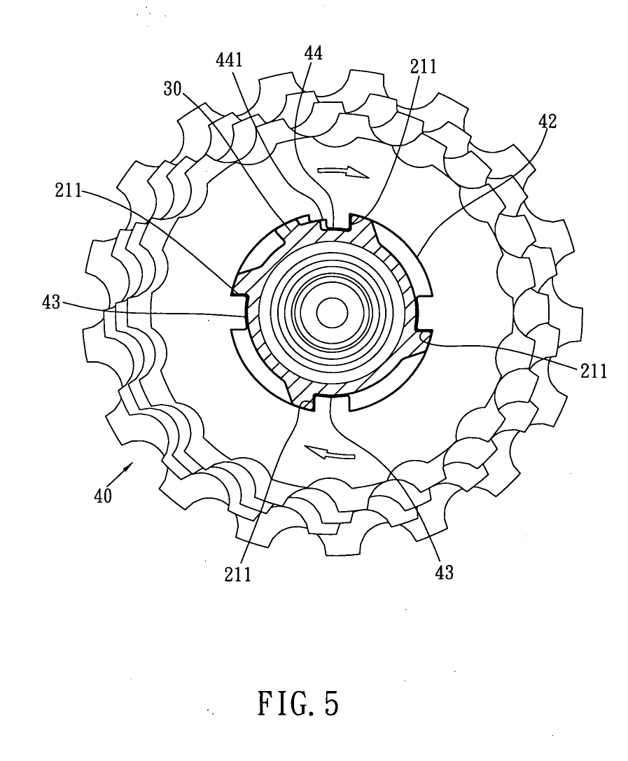

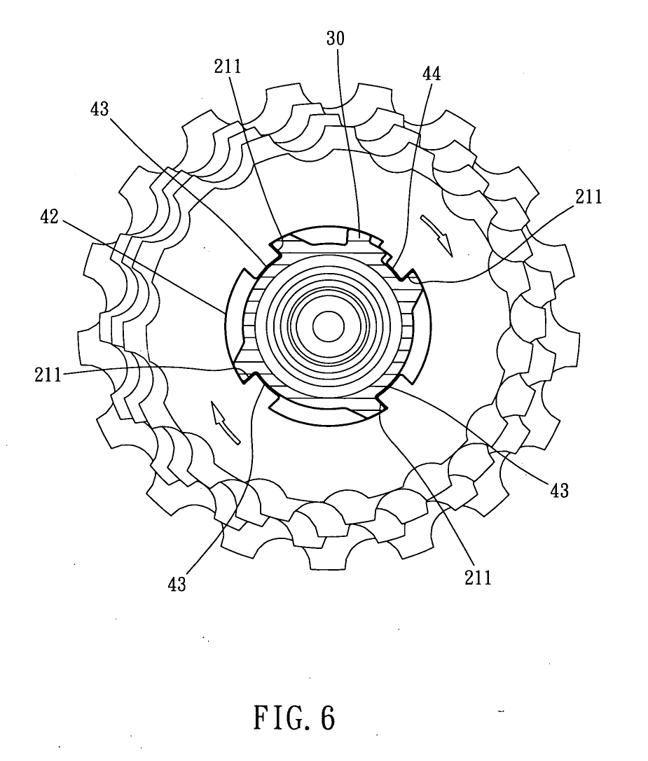

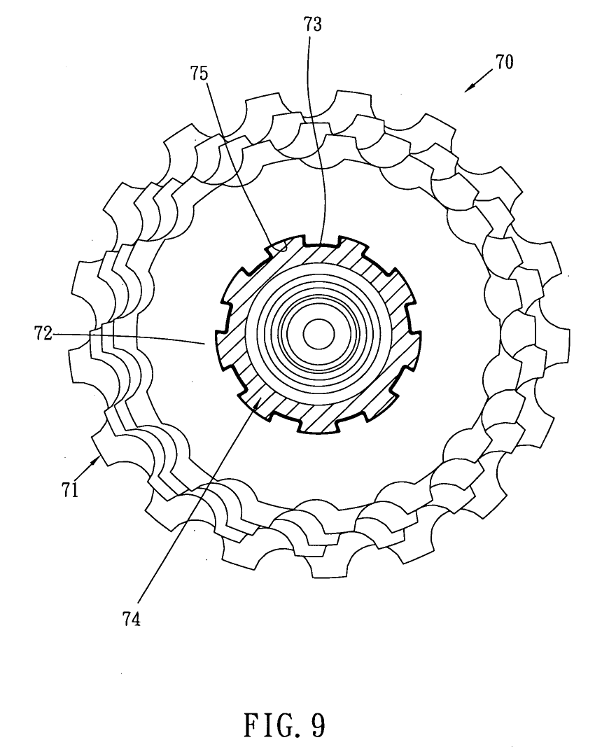

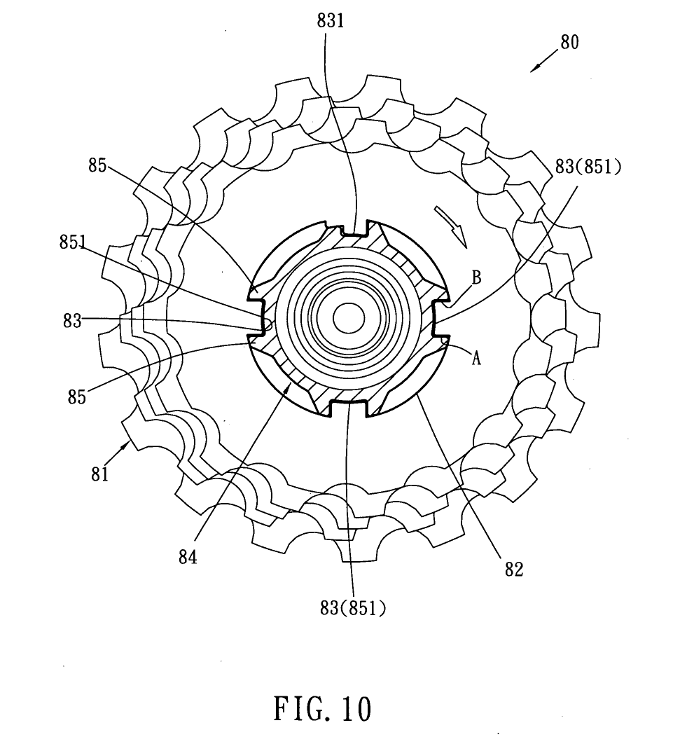

As shown in FIGS. 5 and 6, when the sprocket set 40 rotates, the engaging ribs 43 contact the driving surfaces 211 of the driving ribs 21 so as to rotate the rear wheel hub 50. It is noted that the present invention uses only one elongate rib for each driving rib 21 and only one driving surface 211 is manufactured at higher precision. Compared with the conventional connection tube as shown in FIGS. 9 and 10, the structure of the driving ribs 21 is simplified and the manufacturing cost can be reduced.

It requires a longer assembly time for engaging the connection tube as shown in FIG. 10 to the sprocket set, because the assemblers have to align the respective recesses 851 and the protrusions 83. For the present invention, the driving ribs 21 is a single rib and the distance between the driving ribs 21 is wide enough so that the assemblers can easily engaging the engaging ribs 43 with the driving ribs 21. Each driving rib 21 requires only one driving surface 211 so that the material and the manufacturing processes can be reduced.

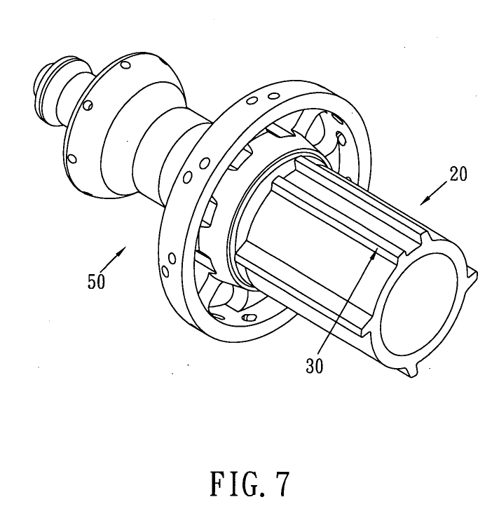

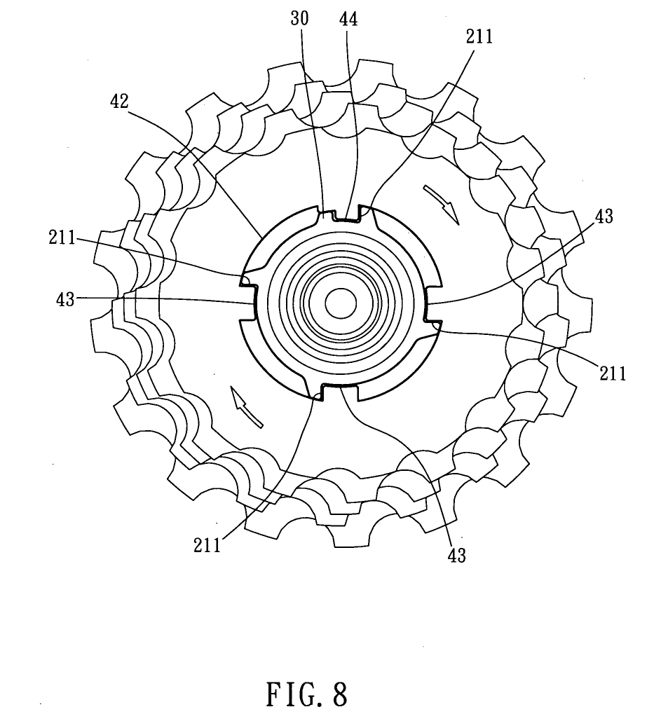

FIGS. 7 and 8 show another embodiment of the present invention wherein the positioning rib 30 is a single elongate rib and a distal end of the positioning rib 30 contacts the assembly rib 441.

While we have shown and described the embodiment in accordance with the present invention, it should be clear to those skilled in the art that further embodiments may be made without departing from the scope of the present invention.

What is claimed is:

1. A connection tube of bicycle rear wheel hub, comprising:
a connection portion extending axially from a first end thereof and being adapted to be connected with the rear wheel hub, an engaging portion extending axially from a second end of the connection tube and adapted to extend from an end of the rear wheel hub, the engaging portion being a hollow tube and four driving ribs extending radially from an outer periphery of the engaging portion, the driving ribs located axially on the engaging portion, each driving rib including a driving surface and an inclined surface on two sides thereof, the driving surface being perpendicular to the outer periphery of the engaging portion and the inclined surface being inclined relative to the outer periphery of the engaging portion, and
a positioning rib extending radially from an outer periphery of the engaging portion and located axially on the engaging portion, the positioning rib located between two driving ribs.

2. The connection tube of bicycle rear wheel hub as claimed in claim 1, wherein a crown surface is connected between the driving surface and the inclined surface of each driving rib.

3. The connection tube of bicycle rear wheel hub as claimed in claim 2, wherein the crown surface has a width between 2 mm to 4 mm.

4. The connection tube of bicycle rear wheel hub as claimed in claim 1, wherein the positioning rib is a stepped rib and includes a first step and a second step which is shorter than the first step.

5. The connection tube of bicycle rear wheel hub as claimed in claim 4, wherein the first step of the positioning rib is located on the same side as the driving surface of each driving rib.
